(19) United States
(12) Patent Application Publication
(10) Pub. No.: US 2026/0050763 A1
(43) Pub. Date: Feb. 19, 2026

(54) GRAPH-BASED DATASET VALUATION TO SOLVE ARTIFICIAL INTELLIGENCE (AI) PROBLEMS

(71) Applicant: HEWLETT PACKARD ENTERPRISE DEVELOPMENT LP, Spring, TX (US)

(72) Inventors: Tarun Kumar, Bangalore (IN); Suparna Bhattacharya, Bangalore (IN); Martin Foltin, Fort Collins, CO (US)

(21) Appl. No.: 18/917,783

(22) Filed: Oct. 16, 2024

(30) Foreign Application Priority Data
Aug. 14, 2024 (IN) 202441061733

(51) Int. Cl. G06N 3/042

(52) U.S. Cl. CPC G06N 3/042

(57) ABSTRACT

Systems and methods are provided for leveraging data lineage information of datasets to estimate the merit (e.g., worth, value, or importance) of these datasets in performing a future task. For example, the dataset may have been historically applied to train an artificial intelligence (AI) model to perform a task (e.g., an artificial intelligence (AI) task like image recognition or object prediction/detection). The learned merit of the dataset in performing the task may be used as input to train a regressor model, and the trained regressor model can be used to predict future merit of the dataset characteristics in performing another task. The predicted future merit of the dataset characteristics can be mapped to the merit of the dataset in performing another task. The future merit may be related to the same dataset or a different dataset, based on the shared characteristics of the datasets.

### BACKGROUND

Effective utilization of data can be integral to solving various technical problems. However, finding and assessing the usefulness of a particular dataset for solving a specific problem can be challenging. One way to address the worth and usefulness of the data can include analyzing the history of how well the particular dataset performed in solving the same problem, but this analysis and determination can become non-trivial when evaluating a dataset's utility for solving entirely new problems.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility, or other organization, in accordance with some examples of the disclosure.

FIG. 2 illustrates datasets and corresponding uses of the same, in accordance with some examples of the disclosure.

FIG. 3 illustrates a lineage graph and a characteristics graph, in accordance with some examples of the disclosure.

FIG. 4 illustrates a characteristics graph for determining a dataset value estimation, in accordance with some examples of the disclosure.

FIG. 5 illustrates a new dataset in comparison to the dataset value estimation generated from the characteristics graph, in accordance with some examples of the disclosure.

FIG. 6 illustrates two datasets with a shared characteristic performing different tasks, in accordance with some examples of the disclosure.

FIG. 7 is a computing platform that may be used to implement examples of the disclosed technology.

FIG. 8 is a computing component that may be used to implement examples of the disclosed technology.

The figures are not exhaustive and do not limit the present disclosure to the precise form disclosed.

### DETAILED DESCRIPTION

The difficulty in analyzing a dataset for applicability to new problems is non-trivial. Examples of the present disclosure address this difficulty by providing a training technique that can leverage data lineage information of datasets to estimate the merit (e.g., worth, value, or importance) of these datasets in performing a future task. For example, the dataset may have been historically applied to train an artificial intelligence (AI) model to perform a task (e.g., an artificial intelligence (AI) task like image recognition or object prediction/detection). The historical application of using the dataset to train an AI model to perform a task may correspond with the lineage of the dataset. The learned merit of the dataset in performing the task may be used as input to train a regressor model, and the trained regressor model can be used to predict future merit of the dataset in performing another task. The future merit may be related to the same dataset or a different dataset, based on the shared characteristics of the datasets, which can either be the same or different but have similar meanings. In this sense, the learned merit can be used to predict a merit of another dataset in performing a task, which may be the same task or a different task used in training the regressor model. The other dataset may be one that has not been previously employed for the task, or not used in any task whatsoever.

As an illustrative example, a first dataset may be stored in a format corresponding with tabular dataset and the column headers may correspond with characteristics of the dataset. The first dataset may comprise various data, including weather characteristics like temperature or moisture. Historically, the first dataset may have been used to ultimately generate an AI prediction related to agriculture (e.g., an AI prediction on the health of the agriculture crop based on the features of the weather). In performing this historical prediction, the first dataset may have been used to train the AI model to perform the prediction. The system may use this historical use of the first dataset to determine how well the first dataset may perform in training other AI models to make similar or dissimilar predictions, or how well a second or other subsequent datasets with similar characteristics may perform in training other AI models to make similar or dissimilar predictions. For example, the second dataset with similar characteristics may be identified to train a future AI model. The determination to use the second dataset may be based on the estimated accuracy of the prediction exceeding an accuracy threshold (e.g., the AI model performed well in predicting the health of the agriculture crop), while using the second dataset to make dissimilar predictions may not exceed the accuracy threshold. In turn, the system can determine that the characteristics of the second dataset, like moisture and temperature from the first dataset, are meaningful to the prediction corresponding with agriculture. But if historically, the first dataset is associated with an AI model that did not perform well for agriculture (e.g., fails to exceed the accuracy threshold for a similar prediction / AI model), the system may determine that the characteristics of the first dataset should not be identified in other datasets for training future AI models, even if the first dataset and second dataset are different from each other.

In an example implementation, data lineage information of datasets used in performing a task (e.g., when the dataset is historically applied to train a model to perform an AI task) may be obtained from lineage graphs. A lineage graph may provide datasets, processes, and models as connected nodes. Each dataset may comprise a number of characteristics (e.g., in tabular datasets, the metadata characteristics include column headers, statistical distribution of values, etc.). These metadata characteristics can also be derived from other associated files such as ReadMe files or from the environment where datasets are used, such as dashboards. Furthermore, entities other than datasets such as processing steps, models, etc. can have their own metadata characteristics (e.g. hyperparameters, architecture design, etc.). Each characteristic can be associated with the dataset as metadata (referred to herein as characteristic metadata). Each characteristic metadata may comprise a characteristic name. The lineage graph may also provide performance metric metadata of the performance of the model in performing a particular task. The performance metric metadata can include a measure of a performance metric (e.g., an accuracy, recall, or the like).

Examples herein may convert the lineage graph into a characteristics graphs by converting the data lineage information into nodes that form the characteristics graphs. For example, for a given lineage graph, each dataset is substituted with a clique closure of its corresponding characteristics. The clique closure comprises nodes, each of which corresponds to a characteristic metadata and represents a particular characteristic. Each node is tagged with a characteristic name and a characteristic embedding, which is a vectorized representation of the characteristic name. The data lineage information is propagated forward and backward along the lineage graph and used to tag each node of the characteristics graph with metadata from other datasets, processes, or model results. In an illustrative example, each node of the characteristics graph can be tagged with a task name, a task embedding, and performance metric metadata (e.g., the measure of a performance metric) of the task. The task embedding is obtained as a vectorized representation of the task name. If the dataset is used for multiple tasks, the node of the characteristics graph can be tagged with multiple task names, multiple task embeddings, and multiple metric metadata.

The characteristics graph can then be used to train a regressor model to estimate a merit (e.g., worth, value, or importance) of multiple characteristics of the dataset in performing the task corresponding to the lineage graph. For example, a Graph Neural Network (GNN) can be trained on nodes of the characteristics graph to learn node embeddings, for each node, from a concatenation of a characteristic embedding and a task embedding of a respective node. In the case of multiple task embeddings, multiple node embeddings may be learned for each node. The node embeddings are then used to train a regression function to learn a mapping between the node embeddings and metric values of the metric metadata associated with each node. The regression function can use this mapping to estimate a merit for each node embedding in performing the task, which can translate to a merit for each characteristic due to the relationship of the node embeddings to the characteristic embeddings and task embeddings.

The trained regressor model can be used to predict a merit of a new dataset in performing a task, which may be the same or a different task as used in training the regressor model above. For example, characteristic metadata can be identified from the new dataset and used to obtain characteristic names and characteristic embeddings. A task description (e.g., task name) can be supplied, which can be vectorized to provide a task embedding. The characteristic embeddings and the task embedding can be concatenated and input into the trained regressor model to calculate an estimate of the merit of each characteristic in performing the task. The merit of the entire dataset can be estimated from the estimated merits of the characteristics by applying the merits of the characteristics to a value assignment function, which can be learned using history data or computed based on operations such maximum, average, or the like. For example, in the case of a maximum assignment function, a dataset's merit may be estimated as equal to the maximum merit of its constituent characteristics. One example of a learnable value assignment function is a regressor that maps estimated merits of the characteristics to dataset merit.

Technical benefits and improvements are described throughout the disclosure. For example, a merit value may be determined for a new dataset to help determine how well the dataset will perform for the AI task without implementing the dataset for the AI task through trial and error. In this sense, the system can assess and measure the dataset prior to its use and determine a ranking of datasets to use for future AI tasks.

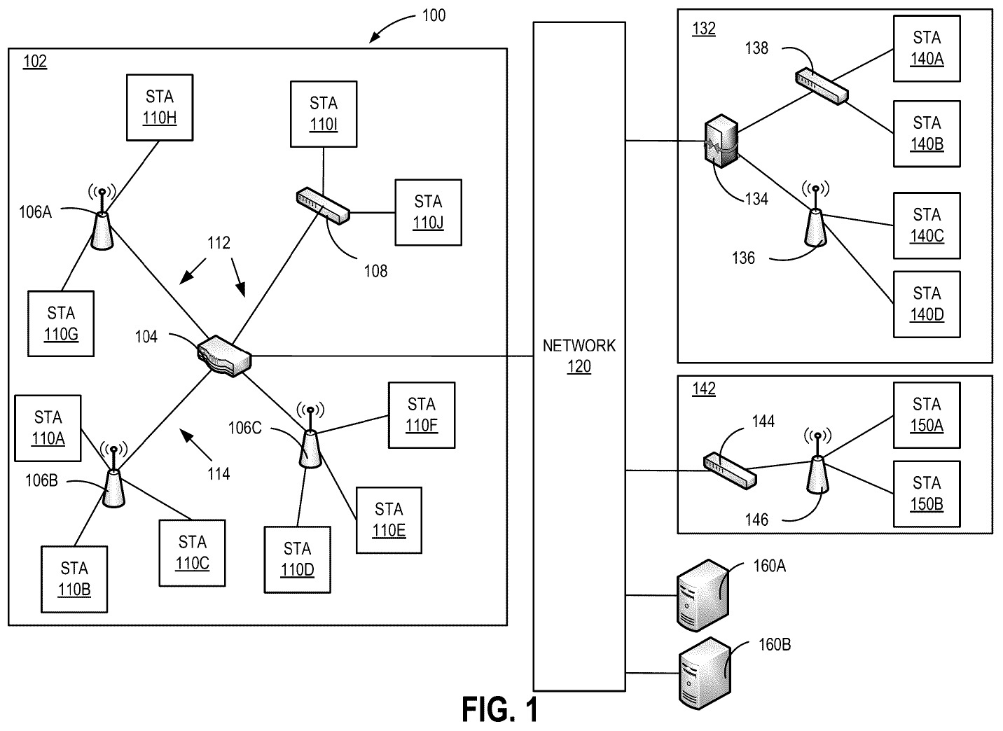

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, and 142. The network configuration 100 may include a primary site 102 in communication with a network 120. The network configuration 100 may also include one or more remote sites 132, 142, that are in communication with the network 120.

The primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, the primary site 102 includes a controller 104, which is in communication with the network 120. The controller 104 may provide communication with the network 120 for the primary site 102. There may be other points of communication with the network 120 for the primary site 102 in addition to controller 104. Although single controller 104 is illustrated, the primary site 102 may include multiple controllers and/or multiple communication points with network 120. In some embodiments, the controller 104 may communicate with the network 120 through a router. In other embodiments, the controller 104 provides router functionality to the devices in the primary site 102. In this specification, the word “tunnel” refers to an encapsulated mode of transporting data between AP and controller.

The controller 104 may be operable to configure and manage network devices, such as at the primary site 102, and may also manage network devices at the remote sites 132, 142. The controller 104 may be operable to configure and/or manage switches, routers, access points, and/or client devices connected to a network. The controller 104 may itself be, or provide the functionality of, an Access Point (AP).

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired or wireless connection 112. In the illustrated example, the switch 108 communicates with the controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by the controller 104. APs 106a-c communicate with the controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with the network 120. A gateway device 134 may be a router, a digital-to-analog modem, a cable modem, a digital subscriber line (DSL) modem, or some other network device configured to communicate with the network 120. The remote site 132 may also include a switch 138 and/or AP 136 in communication with the gateway device 134 over either wired or wireless connections. The switch 138 and AP 136 provide connectivity to the network for various client devices 140a-d.

In various embodiments, the remote site 132 may be in direct communication with primary site 102, such that client devices 140a-d at the remote site 132 access the network resources at the primary site 102 as if these client devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at the remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. The client devices 110a-j, 140a-d, 150a-b may request and access the multimedia content provided by the content servers 160a-b.

In another example, servers 106a-b may comprise flow optimization service server that include various information for provisioning services to client devices 110a-j, 140a-d, 150a-b and optimizing traffic flows in accordance with the examples disclosed herein. The access points 106a-c, 136, and 146; switches 108; and gateway devices 134 and 144 may request or upload information, such as telemetry data, for optimizing rendering of services to client devices 110a-j, 140a-d, 150a-b. The information may include, but is not limited to, a measure or estimate of QoE on a per traffic flow basis (e.g., referred to herein as a QoE score); flow characteristics and other QoS measurements, such as but not limited to, jitter, delay, airtime, latency, etc. ; analytics; transmission protocols (e.g., OFDMA and MU-MIMO), and the like. The information may be stored in a database, which can be communicatively coupled to the servers 160a, 160b. In examples, the servers 160a-b may be cloud-based, which would be understood by those of ordinary skill in the art to refer to being, e.g., remotely hosted on a system/servers in a network (rather than being hosted on local servers/computers) and remotely accessible.

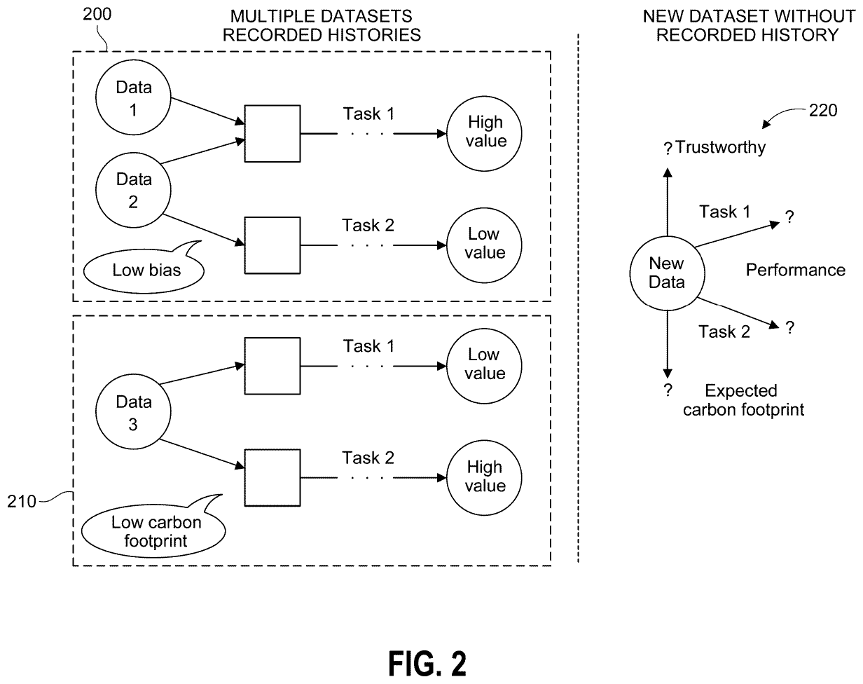

FIG. 2 illustrates datasets and corresponding uses of the same, in accordance with some examples of the disclosure. Various datasets are shown for illustrative purposes and should not be limiting to the disclosure.

In example 200, a first dataset and a second dataset are used to perform two tasks, Task One and Task Two. The use of first dataset and second dataset in Task One results in a high prediction value exceeding a threshold accuracy value and the use of only the second dataset (without the first dataset) in Task Two results in a low prediction value that does not exceed the threshold accuracy value.

In example 210, a third dataset is used to perform two tasks, Task One and Task Two. The use of third dataset in Task One results in a low prediction value that does not exceed a threshold accuracy value and the use of the third dataset in Task Two results in a high prediction value that exceeds the threshold accuracy value.

In example 200 and example 210, the data lineage information of the first dataset, second dataset, and third dataset may be determined to estimate the merit (e.g., worth, value, or importance) of these datasets in performing a future task. For example, the historical application of using the dataset to train an AI model to perform a task (e.g., a prediction) may correspond with the lineage of the datasets used to train the AI model. The future task may be implemented by either of these datasets, or by a new dataset, as shown in example 220.

In example 220, a fourth dataset is received and the system may determine which tasks would yield prediction values that exceed a threshold accuracy value, based on other datasets (e.g., the first dataset, second dataset, or third dataset) that were applied to historical tasks. Various unknown values may be associated with the fourth dataset related to the merit of the fourth dataset, including whether the fourth dataset is trustworthy or accurate, the performance that is associated with the system when processing the fourth dataset or using the fourth dataset for executing a task, or the expected carbon footprint of the fourth dataset, to name a few non-exhaustive examples. In each of these examples, the merit of the fourth dataset may be initially unknown.

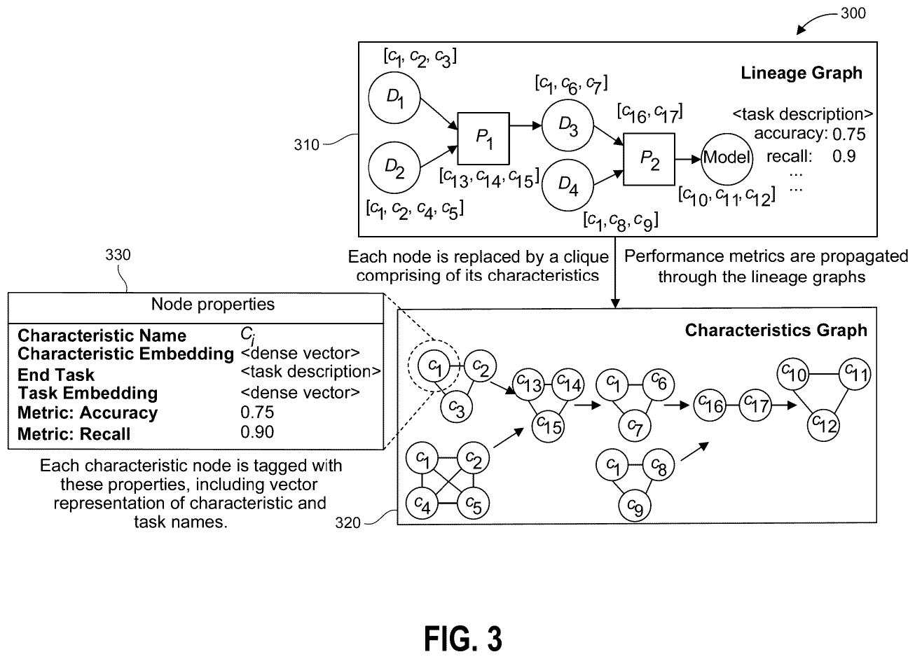

FIG. 3 illustrates a lineage graph and a characteristics graph, in accordance with some examples of the disclosure. In example 300, the data lineage information may be obtained from a data lineage graph of an AI model performing a first task, illustrated as lineage graph 310, where the lineage graph illustrates datasets, processes, and models as connected nodes.

As illustrated, lineage graph 310 may provide datasets, processes, and models as connected nodes, illustrated as D1, D2, D3, and D4 in example 300. Each dataset may comprise a number of characteristics (e.g., in tabular datasets, the metadata characteristics include column headers). For example, the characteristics for D1 comprise [C1, C2, C3], the characteristics for D2 comprise [C1, C2, C4, C5], the characteristics for D3 comprise [C1, C6, C7], and the characteristics for D4 comprise [C1, C8, C9]. Each characteristic can be associated with characteristic metadata. Each characteristic metadata may comprise a characteristic name (e.g., C1, C2, etc.). As shown, characteristic C1 is repeated across all datasets D1, D2, D3, and D4 and characteristic C2 is repeated across a subset of the datasets D1 and D2.

Lineage graph 310 may also provide performance metric metadata of the performance of the model in performing a particular task, illustrated as P1 and P2. The performance metric metadata can include a measure of a performance metric (e.g., an accuracy, recall, or the like) as a metric value. The performance metric may also comprise characteristics. For example, the characteristics for P1 comprise [C13, C14, C15] and the characteristics for P2 comprise [C16, C17].

Lineage graph 310 may also comprise a set of characteristics associated with the model in performing the task. For example, the model may correspond with a set of characteristics from the datasets that were used to train the model to perform the task. In this illustration, the model corresponds with characteristics [C10, C11, C12], which may not be taken directly from the datasets yet learned through the execution of the task. The model may comprise characteristic metadata of a first dataset input and metric metadata of a performance of the model in performing the first task. In this example, the metric metadata is illustrated as accuracy (e.g., 0.75 or 75% accuracy metric value) and recall (e.g., 0.9 or 90% recall metric value).

In some examples, lineage graph 310 is converted into a characteristics graph, illustrated as characteristics graph 320. For example, the conversion may receive the data lineage information from lineage graph 310 and use it to generate characteristics graph 320, in part, by generating a node of the characteristics graph based on the characteristic metadata and the metric metadata. In some examples, each node in the lineage graph is replaced by its characteristics converted as nodes in the characteristics graph.

The nodes in characteristics graph 320 may comprise a set of node properties 330. For example, node properties 330 may comprise a characteristic name, characteristic embedding, end task, task embedding, and one or more metric values (e.g., accuracy, recall, etc.). The nodes in characteristics graph 320 may be tagged with node properties 330, including vector representation of characteristic and task names.

Node properties 330 may be generated through a propagation of the data lineage information throughout characteristics graph 320. For example, data lineage information is propagated forward and backward along the lineage graph and used to tag each node of the characteristics graph with metadata from other datasets, processes, or model results. In an illustrative example, each node of the characteristics graph can be tagged with a task name, a task embedding, and performance metric metadata (e.g., the measure of a performance metric) of the task. The task embedding is obtained as a vectorized representation of the task name. If the dataset is used for multiple tasks, the node of the characteristics graph can be tagged with multiple task names, multiple task embeddings, and multiple metric metadata.

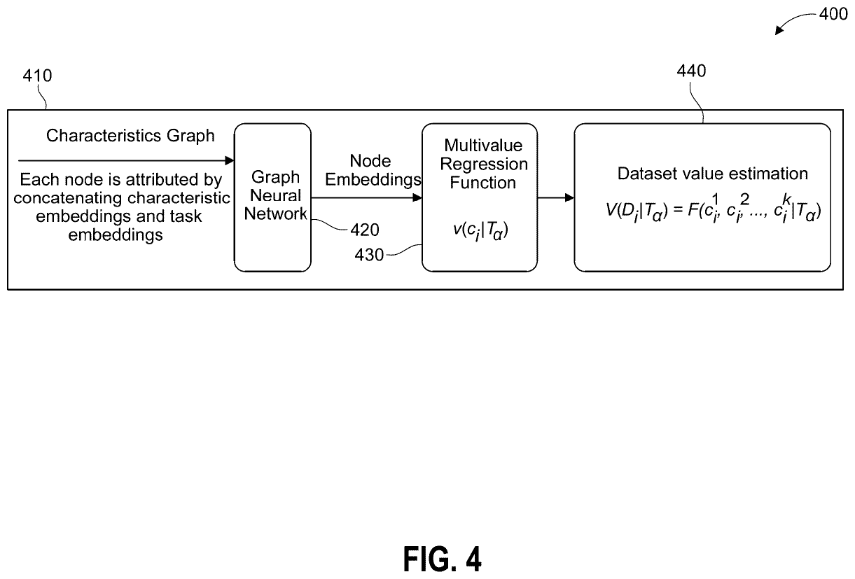

FIG. 4 illustrates a characteristics graph for determining a dataset value estimation, in accordance with some examples of the disclosure. In illustration 400, characteristics graph 410 can be used to train a regressor model. The regressor model to estimate a merit (e.g., worth, value, or importance) of the characteristic metadata in performing the first task based on the node of the characteristics graph.

For example, a Graph Neural Network (GNN) 420 can be trained on nodes of characteristics graph 410 to learn node embeddings, for each node, from a concatenation of a characteristic embedding and a task embedding of a respective node.

In some examples, the node embeddings may correspond with low-dimensional vector representations of nodes in the graph. The node embeddings may store the structural and relational information of nodes based on their connections (edges) and the network topology. In the case of multiple task embeddings, multiple node embeddings may be learned for each node. The node embeddings may be used to train regression function 430. Regression function 430 may predict a continuous numerical output (e.g., the target variable for the regression) based on input variables (e.g., the vector representation of the nodes) to learn a mapping between the node embeddings and metric values of the metric metadata associated with each node.

In some examples, regression function 430 can use this mapping to estimate a merit value for each node embedding in performing the task. The merit value can translate to a merit (e.g., worth, value, or importance) for each characteristic due to the relationship of the node embeddings to the characteristic embeddings and task embeddings.

Regression function 430 can be trained and then used to predict a merit value 440 of a second dataset that performs a second task. In some examples, the predicted merit value may correspond with the merit value of the new dataset in performing a task, which may be the same or a different task as used in training the regressor model described above. For example, characteristic metadata can be identified from the new dataset and used to obtain characteristic names and characteristic embeddings. A task description (e.g., task name) can be supplied, which can be vectorized to provide a task embedding. The characteristic embeddings and the task embedding can be concatenated and input into the trained regressor model to calculate an estimate of the merit of each characteristic in performing the task. The merit of the entire dataset can be estimated from the estimated merits of the characteristics by applying the merits of the characteristics to a value assignment function, which can be learned using history data or computed based on operations such maximum, average, or the like. For example, in the case of a maximum assignment function, a dataset's merit may be estimated as equal to the maximum merit of its constituent characteristics. One example of a learnable value assignment function is a regressor that maps estimated merits of the characteristics to dataset merit.

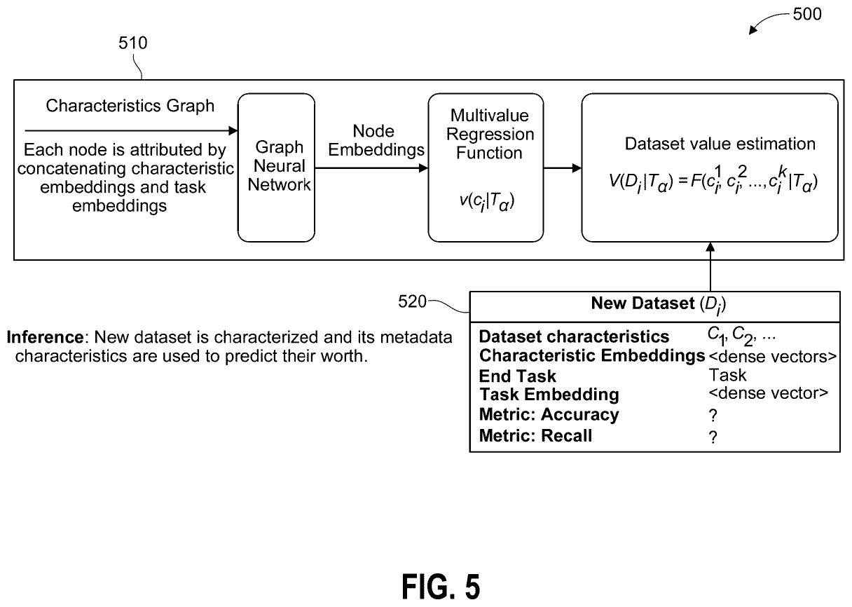

FIG. 5 illustrates a new dataset in comparison to the dataset value estimation generated from the characteristics graph, in accordance with some examples of the disclosure. In example 500, new dataset 520 is received and provided for an inference stage using the trained regressor model. In this example, the characteristics of the new dataset may be identified and the system may obtain the characteristic name Ci, its embedding vector e(Ci) and task description Tα and its embeddings e(Tα). Each of these values may be concatenated <e(Ci), e(Tα)>. Using the learned regression function, calculate the estimated value of the characteristic to solve the given task. In some examples, the system may determine a suitable definition of a dataset value assignment function, such as a maximum calculation or an average calculation, or learn it from the history data of <characteristic value, dataset value> pairs, and estimate the merit value of the dataset.

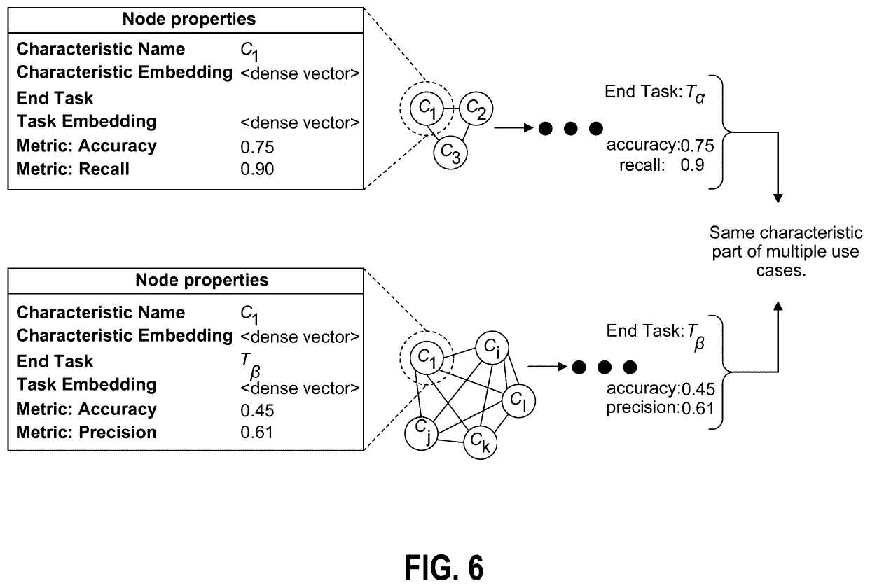

FIG. 6 illustrates two datasets with a shared characteristic performing different tasks, in accordance with some examples of the disclosure. In example 600, a same characteristic may be used in different contexts. For example, characteristic C1 appears in two contexts. The characteristics graph associated with these tasks may include two occurrences of the characteristic C1 with different task descriptions. In some examples, each occurrence of characteristic C1 as a separate node.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

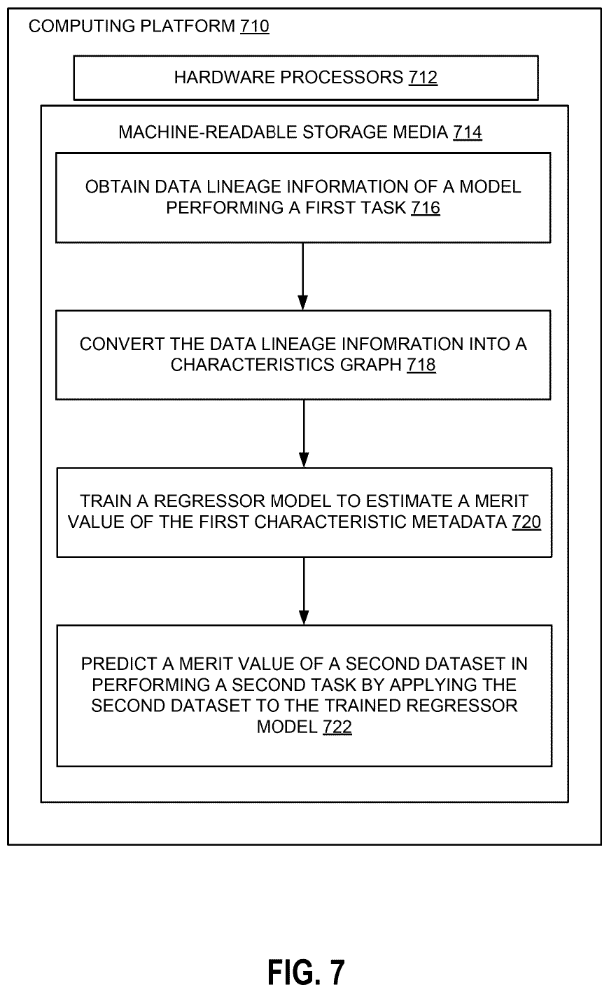

FIG. 7 illustrates a computing component that may be used to implement burst preloading for available bandwidth estimation in accordance with various examples of the disclosed technology. Referring now to FIG. 7, computing component 710 may be, for example, a server computer, a controller, or any other similar computing component capable of processing data. In the example implementation of FIG. 7, the computing component 710 includes a hardware processor 712, and machine-readable storage medium 714.

Hardware processor 712 may be one or more central processing units (CPUs), semiconductor-based microprocessors, and/or other hardware devices suitable for retrieval and execution of instructions stored in machine-readable storage medium 714. Hardware processor 712 may fetch, decode, and execute instructions, such as instructions 716-722, to control processes or operations for burst preloading for available bandwidth estimation. As an alternative or in addition to retrieving and executing instructions, hardware processor 712 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 714, may be any electronic, magnetic, optical, or other physical storage device that contains or stores executable instructions. Thus, machine-readable storage medium 714 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 714 may be a non-transitory storage medium, where the term “non-transitory” does not encompass transitory propagating signals. As described in detail below, machine-readable storage medium 714 may be encoded with executable instructions, for example, instructions 716-722.

Hardware processor 712 may execute instruction 716 to obtain data lineage information of a model performing a first task. In some examples, the data lineage information may comprise a first set of characteristic metadata of first set of datasets input into the model for performing the first task and metric metadata of a performance of the model in performing the first task.

In an example implementation, data lineage information of datasets used in performing a task (e.g., when the dataset is historically applied to train a model to perform an AI task) may be obtained from lineage graphs. A lineage graph may provide datasets, processes, and models as connected nodes. Each dataset may comprise a number of characteristics (e.g., in tabular datasets, the metadata characteristics include column headers, statistical distribution of values, etc.). These metadata characteristics can also be derived from other associated files such as ReadMe files or from the environment where datasets are used, such as dashboards. Furthermore, entities other than datasets such as processing steps, models, etc. can have their own metadata characteristics (e.g. hyperparameters, architecture design, etc.). Each characteristic can be associated with the dataset as metadata (referred to herein as characteristic metadata). Each characteristic metadata may comprise a characteristic name. The lineage graph may also provide performance metric metadata of the performance of the model in performing a particular task. The performance metric metadata can include a measure of a performance metric (e.g., an accuracy, recall, or the like).

Hardware processor 712 may execute instruction 718 to convert the data lineage information into a characteristics graph. In some examples, converting the data lineage information into a characteristics graph is associated with, in part, generating a node of the characteristics graph based on the first set of characteristic metadata and the metric metadata.

In some examples, the system may convert the lineage graph into a characteristics graphs by converting the data lineage information into nodes that form the characteristics graphs. For example, for a given lineage graph, each dataset is substituted with a clique closure of its corresponding characteristics. The clique closure comprises nodes, each of which corresponds to a characteristic metadata and represents a particular characteristic. Each node is tagged with a characteristic name and a characteristic embedding, which is a vectorized representation of the characteristic name. The data lineage information is propagated forward and backward along the lineage graph and used to tag each node of the characteristics graph with metadata from other datasets, processes, or model results. In an illustrative example, each node of the characteristics graph can be tagged with a task name, a task embedding, and performance metric metadata (e.g., the measure of a performance metric) of the task. The task embedding is obtained as a vectorized representation of the task name. If the dataset is used for multiple tasks, the node of the characteristics graph can be tagged with multiple task names, multiple task embeddings, and multiple metric metadata.

Hardware processor 712 may execute instruction 720 to train a regressor model. In some examples, the regressor model may be trained to estimate a merit value of the first set of characteristic metadata in performing the first task based on the node of the characteristics graph.

In some examples, the characteristics graph can then be used to train a regressor model to estimate a merit (e.g., worth, value, or importance) of multiple characteristics of the dataset in performing the task corresponding to the lineage graph. For example, a Graph Neural Network (GNN) can be trained on nodes of the characteristics graph to learn node embeddings, for each node, from a concatenation of a characteristic embedding and a task embedding of a respective node. In the case of multiple task embeddings, multiple node embeddings may be learned for each node. The node embeddings are then used to train a regression function to learn a mapping between the node embeddings and metric values of the metric metadata associated with each node. The regression function can use this mapping to estimate a merit for each node embedding in performing the task, which can translate to a merit for each characteristic due to the relationship of the node embeddings to the characteristic embeddings and task embeddings.

Hardware processor 712 may execute instruction 722 to predict a merit value of a second set of datasets in performing a second task by applying the second set of datasets to the trained regressor model. In some examples, the second set of datasets being partially or completely absent from performing the first task or the second task.

In some examples, the trained regressor model can be used to predict a merit of a new dataset in performing a task, which may be the same or a different task as used in training the regressor model above. For example, characteristic metadata can be identified from the new dataset and used to obtain characteristic names and characteristic embeddings. A task description (e.g., task name) can be supplied, which can be vectorized to provide a task embedding. The characteristic embeddings and the task embedding can be concatenated and input into the trained regressor model to calculate an estimate of the merit of each characteristic in performing the task. The merit of the entire dataset can be estimated from the estimated merits of the characteristics by applying the merits of the characteristics to a value assignment function, which can be learned using history data or computed based on operations such maximum, average, or the like. For example, in the case of a maximum assignment function, a dataset's merit may be estimated as equal to the maximum merit of its constituent characteristics. One example of a learnable value assignment function is a regressor that maps estimated merits of the characteristics to dataset merit.

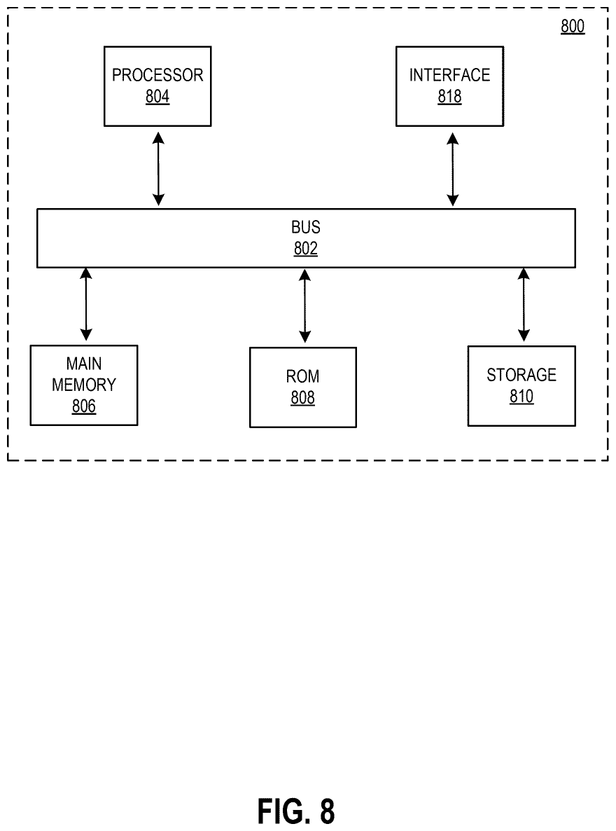

FIG. 8 depicts a block diagram of an example computer system 800 in which various examples of the disclosed technology described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one example of the disclosed technology, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes interface 818 coupled to bus 802. Interface 818 provides a two-way data communication coupling to one or more network links that are connected to one or more local networks. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN (or WAN component to communicate with a WAN). Wireless links may also be implemented. In any such implementation, interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 818, which carry the digital data to and from computer system 800, are example forms of transmission media.

The computer system 800 can send messages and receive data, including program code, through the network(s), network link and interface 818. In the Internet example, a server might transmit a requested code for an application program through the Internet, the ISP, the local network and interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
obtaining data lineage information of a model performing a first task, the data lineage information comprising a first set of characteristic metadata of first set of datasets input into the model for performing the first task and metric metadata of a performance of the model in performing the first task;
converting the data lineage information into a characteristics graph, in part, by generating a node of the characteristics graph based on the first set of characteristic metadata and the metric metadata;
training a regressor model to estimate a merit value of the first set of characteristic metadata in performing the first task based on the node of the characteristics graph; and
predicting a merit value of a second set of datasets in performing a second task by applying the second set of datasets to the trained regressor model, the second set of datasets being absent from performing the first task or the second task.

2. The method of claim 1, wherein the data lineage information is obtained from a lineage graph.

3. The method of claim 1, wherein converting the data lineage information into a characteristics graph comprises:
generating a clique closure of the first data lineage as nodes representing the first set of characteristic metadata.

4. The method of claim 3, wherein the clique closure comprises nodes and each of the nodes corresponds to a characteristic metadata.

5. The method of claim 3, wherein the clique closure comprises nodes that each represent a particular characteristic and is tagged with a characteristic name.

6. The method of claim 3, wherein converting the data lineage information into a characteristics graph further comprises:
generating a first task embedding as a vector representation of the first task; and
associating the metric metadata to the node.

7. The method of claim 3, wherein training the regressor model to estimate the merit value of the first characteristic metadata in performing the first task comprises:
training a Graph Neural Network (GNN) to obtain node embeddings for the nodes of the first set of characteristics graph based on the first characteristic embedding and the first task embedding; and
training the regressor model to map the merit value to the node embedding,
wherein the merit of the first characteristic metadata in performing the first task is estimated from the mapping of the merit value to the node embeddings.

8. The method of claim 1, wherein predicting the merit of the second set of datasets in performing the second task comprises:
identifying second set of characteristic metadata of the second set of datasets;
obtaining a second set of characteristic embeddings and a second task embedding, wherein the second set of characteristic embeddings are vector representations names of the second set of characteristic metadata, and wherein the second task embedding is a vector representation of a name of the second task;
applying the second set of characteristic embeddings and the second task embedding to the trained regressor model to derive a merit of the second set of characteristic metadata in performing the second task; and
estimate estimating a merit of the second set of datasets in performing the second task based on the derived merit of the second set of characteristics.

9. A system comprising:
a memory; and
a processor that are configured to execute machine readable instructions stored in the memory for causing the processor to:
obtain data lineage information of a model performing a first task, the data lineage information comprising first set of characteristic metadata of first set of datasets input into the model for performing the first task and metric metadata of a performance of the model in performing the first task;
convert the data lineage information into a characteristics graph, in part, by generating a node of the characteristics graph based on the first set of characteristic metadata and the metric metadata;
train a regressor model to estimate a merit value of the first set of characteristic metadata in performing the first task based on the node of the characteristics graph; and
predict a merit value of a second set of datasets in performing a second task by applying the second set of datasets to the regressor model, the second set of datasets being absent from performing the first task or the second task.

10. The system of claim 9, wherein the data lineage information is obtained from a lineage graph.

11. The system of claim 9, wherein the processor is further caused to:
generate a clique closure of the first data lineage as nodes representing the first set of characteristic metadata.

12. The system of claim 11, wherein the processor is further caused to:
generate a first task embedding as a vector representation of the first task; and
associate the metric metadata to the node.

13. The system of claim 11, wherein the processor is further caused to:
train a Graph Neural Network (GNN) to obtain node embeddings for the nodes of the first set of characteristics graph based on the first set of characteristic embeddings and the first task embedding; and
train the regressor model to map the merit value to the node embedding,
wherein the merit of the first characteristic metadata in performing the first task is estimated from the mapping of the merit value to the node embeddings.

14. The system of claim 9, wherein the processor is further caused to:
identify second characteristic metadata of the second dataset;
obtain a second characteristic embedding and a second task embedding, wherein the second characteristic embedding is a vector representation of a name of the second characteristic metadata, and wherein the second task embedding is a vector representation of a name of the second task;
apply the second characteristic embedding and the second task embedding to the regressor model to derive a merit of the second characteristic metadata in performing the second task; and
estimate a merit of the second dataset in performing the second task based on the derived merit of the second characteristic.

15. A non-transitory computer-readable storage medium storing a plurality of instructions executable by a processor, the plurality of instructions when executed by the processor cause the processor to:
obtain data lineage information of a model performing a first task, the data lineage information comprising first set of characteristic metadata of first set of datasets input into the model for performing the first task and metric metadata of a performance of the model in performing the first task;
convert the data lineage information into a characteristics graph, in part, by generating a node of the characteristics graph based on the first set of characteristic metadata and the metric metadata;
train a regressor model to estimate a merit value of the first set of characteristic metadata in performing the first task based on the node of the characteristics graph; and
predict a merit value of a second set of datasets in performing a second task by applying the second set of datasets to the regressor model, the second set of datasets being absent from performing the first task or the second task.

16. The non-transitory computer-readable storage medium of claim 15, wherein the data lineage information is obtained from a lineage graph.

17. The non-transitory computer-readable storage medium of claim 15, wherein converting the data lineage information into a characteristics graph comprises:
generating a clique closure of the first data lineage as nodes representing the first set of characteristic metadata.

18. The non-transitory computer-readable storage medium of claim 17, wherein converting the data lineage information into a characteristics graph further comprises:
generating a first task embedding as a vector representation of the first task; and
associating the metric metadata to the node.

19. The non-transitory computer-readable storage medium of claim 17, wherein training the regressor model to estimate the merit value of the first characteristic metadata in performing the first task comprises:
training a Graph Neural Network (GNN) to obtain node embeddings for the nodes of the characteristics graph based on the first set of characteristics embeddings and the first task embedding; and
training the regressor model to map the merit value to the node embedding,
wherein the merit of the first characteristic metadata in performing the first task is estimated from the mapping of the merit value to the node embeddings.

20. The non-transitory computer-readable storage medium of claim 17, wherein predicting the merit of the second dataset in performing the second task comprises:
identifying second set of characteristic metadata of the second set of datasets;
obtaining a second set of characteristic embeddings and a second task embedding, wherein the second set of characteristic embeddings are vector representations names of the second set of characteristic metadata, and wherein the second task embedding is a vector representation of a name of the second task;
applying the second set of characteristic embeddings and the second task embedding to the trained regressor model to derive a merit of the second set of characteristic metadata in performing the second task; and
estimate estimating a merit of the second set of datasets in performing the second task based on the derived merit of the second set of characteristics.
